(19) United States
(12) Patent Application Publication
(10) Pub. No.: US 2013/0078489 A1
(43) Pub. Date: Mar. 28, 2013

(54) COOLING STRUCTURE FOR IN-VEHICLE BATTERY

(71) Applicants: Shingo KATO, Tokyo (JP); Ko INAMURA, Tokyo (JP); Narimitsu YOSHII, Tokyo (JP); Takayasu DAIKOHARA, Tokyo (JP)

(72) Inventors: Shingo KATO, Tokyo (JP); Ko INAMURA, Tokyo (JP); Narimitsu YOSHII, Tokyo (JP); Takayasu DAIKOHARA, Tokyo (JP)

(73) Assignee: Fuji Jukogyo Kabushiki Kaisha, Tokyo (JP)

(21) Appl. No.: 13/609,035

(22) Filed: Sep. 10, 2012

(30) Foreign Application Priority Data
Sep. 26, 2011 (JP) 2011-208833

(51) Int. Cl. H01M 10/50

(52) U.S. Cl. 429/83

(57) ABSTRACT

There is provided a cooling structure for an in-vehicle battery. The cooling structure for an in-vehicle battery includes: a battery pack housing a battery cell in a case and loaded into a lower part of a vehicle body; an intake duct for introducing cooling air into the battery pack; and an exhaust duct for discharging the cooling air discharged from the battery pack. A part of at least one of the intake duct and the exhaust duct is disposed along an end of the battery pack in a vehicle width direction and has a lower crushing strength with respect to an input in the vehicle width direction than the battery pack.

### CROSS-REFERENCE TO RELATED APPLICATIONS

The present application claims priority from Japanese Patent Application No. 2011-206833 filed on Sep. 26, 2011, the entire contents of which are hereby incorporated by reference.

### BACKGROUND OF THE INVENTION

1. Field of the Invention

The present invention relates to a cooling structure for an in-vehicle battery, and more particularly to a structure with which both a crushable stroke relative to a side-on collision and a battery loading capacity are secured.

2. Description of the Related Art

A battery pack in which secondary battery cells such as lithium ion batteries are housed in a case is loaded into an electric vehicle such as an engine-electric hybrid vehicle, a plug-in hybrid vehicle, or an electric automobile, for example.

When the vehicle is a passenger vehicle, it has been proposed that a battery pack such as that described above be loaded in a cabin under floor portion in order to lower a center of gravity of the vehicle and secure luggage space and so on.

This type of in-vehicle battery pack is typically provided with a cooling apparatus that prevents the batteries from deteriorating by maintaining a temperature thereof during charging and discharging within an appropriate range.

As related art pertaining to cooling of an in-vehicle battery pack, Japanese Unexamined Patent Application Publication (JP-A) No. H9-99745, for example, describes a battery cooling apparatus for an electric automobile in which a plurality of batteries are housed at intervals in a box loaded under a vehicle floor, an outside air introduction port is provided in a front end of the box, and a plurality of fans are provided in a rear end of the box.

Further, JP-A No. 2006-324041 describes an in-vehicle battery pack in which an intake duct and an exhaust duct are provided in ends on respective sides of a battery pack constituted by a plurality of battery modules so that air flows through the battery pack in a horizontal direction.

Furthermore, JP-A No. 2010-33799 describes a storage device in which storage modules respectively constituted by a plurality of storage elements are disposed in parallel, an air intake duct is provided on an outer side thereof, and adjacent exhaust ducts are disposed for each of the storage modules on an inner side.

An in-vehicle battery pack is required to protect the battery cells without being crushed, even when the vehicle crashes.

When the battery pack is loaded under the floor, however, in order to secure a crushable stroke from a side frame to the battery pack, a capacity (a vehicle width direction dimension) of the battery pack must be reduced by an amount corresponding to the crushable stroke, making it impossible to install enough battery cells to obtain a required performance in the vehicle.

To secure a sufficient capacity in the battery pack, on the other hand, a height direction dimension of the battery pack must be increased, leading to a reduction in a minimum ground clearance of a vehicle body or an increase in a height of a vehicle body floor surface, and as a result, passenger comfort, luggage capacity, and so on may deteriorate.

Furthermore, when a vehicle height is increased, a center of gravity position is raised even though the minimum ground clearance remains similar to that of a pre-existing non-electric vehicle, and as a result, a traveling performance deteriorates.

### SUMMARY OF THE INVENTION

In consideration of the problems described above, an object of the present invention is to provide a cooling structure for an in-vehicle battery with which both a crushable stroke relative to a side-on collision and a battery loading capacity are secured.

An aspect of the present invention provides a cooling structure for an in-vehicle battery. The cooling structure for an in-vehicle battery includes: a battery pack housing a battery cell in a case and loaded into a lower part of a vehicle body; an intake duct for introducing cooling air into the battery pack; and an exhaust duct for discharging the cooling air discharged from the battery pack, wherein a part of at least one of the intake duct and the exhaust duct is disposed along an end of the battery pack in a. vehicle width direction and has a lower crushing strength with respect to an input in the vehicle width direction than the battery pack.

According to this configuration, when a side-on collision occurs in the vehicle, the intake duct or the exhaust duct is crushed such that a space in which the intake duct or the exhaust duct is disposed serves as a crushable space. As a result, a crushable stroke can be secured in the vehicle body while protecting the battery pack.

Hence, the need to secure a crushable stroke by reducing a width of the battery pack decreases, and therefore an increase in an up-down direction dimension of the battery pack can be avoided. As a result, a reduction in the minimum ground clearance, raising of the center of gravity, a reduction in cabin space, and so on can be prevented.

Preferably, the battery pack includes a left battery pack and a right battery pack disposed separately on left and right sides of the vehicle body, and one of the intake duct and the exhaust duct is disposed at least partially along a vehicle width direction outside end of the left battery pack and the right battery pack and has a lower crushing strength with respect to an input in the vehicle width direction than the battery pack.

According to this configuration, the battery packs are loaded on the left and right sides so as to sandwich a propeller shaft and so on, and therefore the effects described above can be obtained.

Preferably, the other of the intake duct and the exhaust duct is disposed at least partially along a vehicle width direction inside end of the left battery pack and the right battery pack.

According to this configuration, cooling air can be caused to flow through the respective battery packs in the vehicle width direction, and therefore an equal amount of air can be passed through each battery cell. As a result, temperature management can be performed appropriately on the respective battery cells.

### BRIEF DESCRIPTION OF THE DRAWINGS

FIG. 1 is a pattern diagram showing a configuration of a first example of a cooling structure for an in-vehicle battery to which the present invention is applied;

FIG. 2 is a pattern diagram showing a configuration of a second example of the cooling structure for an in-vehicle battery to which the present invention is applied; and

FIG. 3 is a pattern diagram showing a configuration of a third example of the cooling structure for an in-vehicle battery to which the present invention is applied.

### DESCRIPTION OF THE PREFERRED EMBODIMENTS

The present invention solves the problem of providing a cooling structure for an in-vehicle battery with which both a crushable stroke relative to a side-on collision and a battery loading capacity are secured by disposing an intake duct or an exhaust duct having a lower crushing strength than a case of a battery pack on a side end of the battery pack in a vehicle width direction so that during a side-on collision, the intake duct or exhaust duct is crushed, whereby a crushable stroke is secured.

### First Example

A first example of the cooling structure for an in-vehicle battery to which the present invention is applied will be described below.

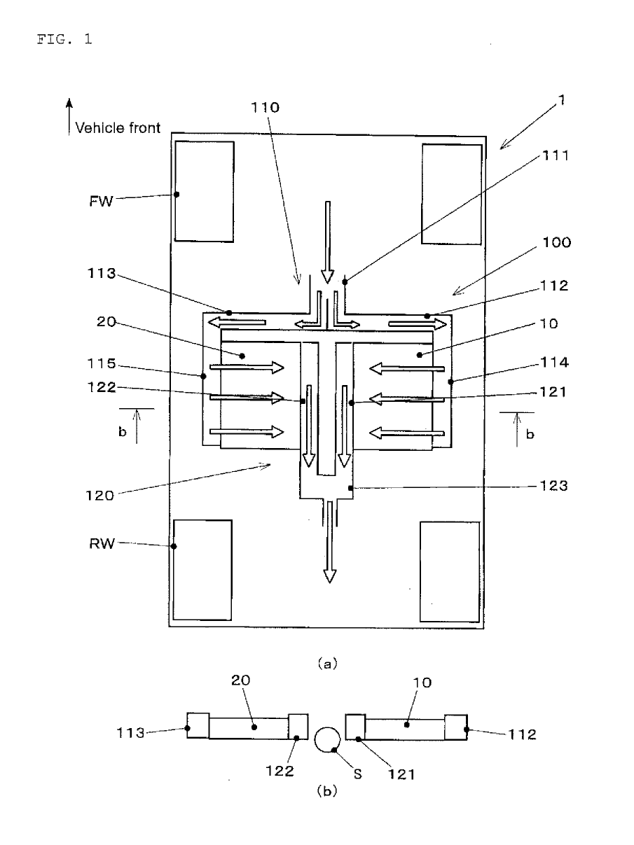

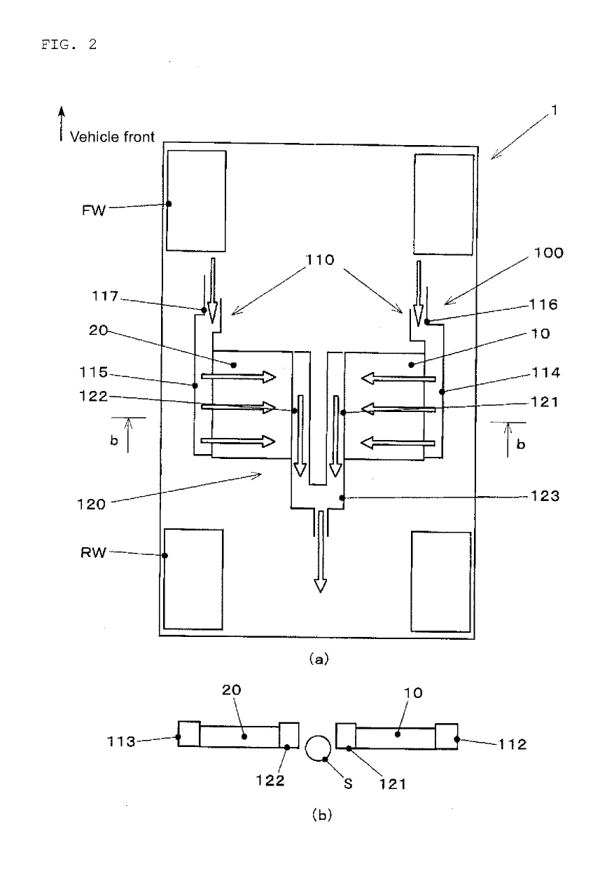

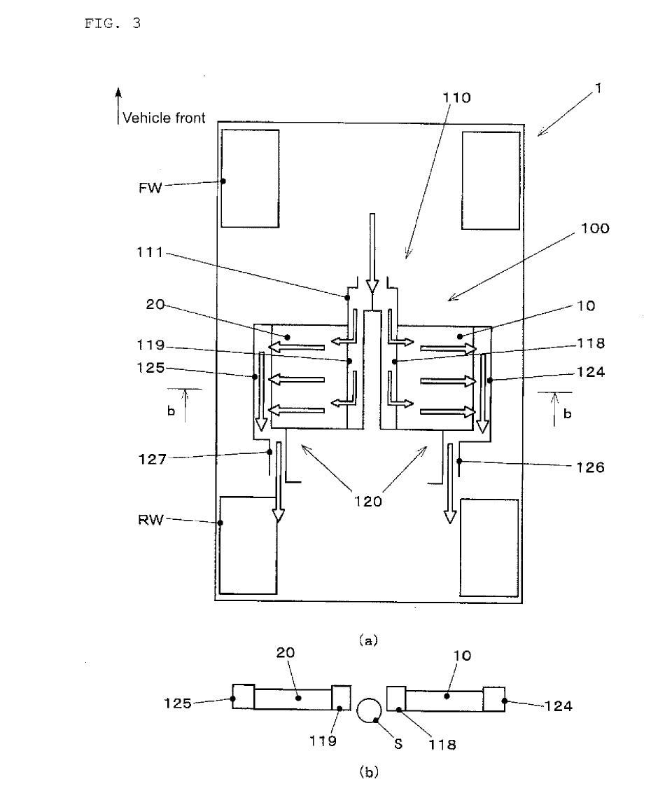

FIG. 1 is a pattern diagram showing a configuration of the cooling structure for an in-vehicle battery according to the first example, wherein FIG. 1A is a plan view seen from an under floor side and FIG. 1E is a sectional view seen from arrows of a b-b region in FIG. 1A (likewise in FIGS. 2 and 3).

In the first example, a vehicle 1 is a four-wheel passenger vehicle having respective left-right pairs of front wheels FW and rear wheels RW, for example.

The vehicle 1 is, for example, an engine-electric hybrid vehicle that includes an engine and a motor/generator, not shown in the drawing, and uses the motor/generator to perform driving assistance and regenerative power generation.

The vehicle 1 includes a left battery pack 10, a right battery pack 20, and so on, which are loaded between wheel bases so as to be suspended from a lower part of a floor panel.

The left battery pack 10 and the right battery pack 20 respectively include secondary batteries that are charged by power generated by the motor/generator and supply power to the motor/generator during driving assistance.

The left battery pack 10 and the right battery pack 20 house a plurality of battery cells such as lithium ion batteries or nickel hydrogen batteries, for example, in respective cases.

The left battery pack 10 and the right battery pack 20 are provided respectively in left and right central areas of a vehicle body and disposed respectively on left and right sides of a floor tunnel housing a propeller shaft, an exhaust pipe, and the like so as to sandwich the floor tunnel.

Side frames of the vehicle body, not shown in the drawing, are disposed adjacent to respective vehicle width direction outside ends of the left battery pack 10 and the right battery pack 20.

Further, the left battery pack 10 and the right battery pack 20 are provided with a cooling apparatus 100 that forcibly cools the battery cells in the interior thereof.

Note that a flow of cooling air formed by the cooling apparatus 100 is indicated by arrows in FIG. 1.

The cooling apparatus 100 includes an intake duct 110 and an exhaust duct 120.

The intake duct 110 is a conduit for taking in outside air and supplying the air to the left battery pack 10 and the right battery pack 20.

The exhaust duct 120 is a conduit for discharging the air that has passed through the left battery pack 10 and the right battery pack 20 to the outside.

Further, a blower device for forcibly conveying the air is provided in at least one of the intake duct 110 and the exhaust duct 120.

The intake duct 110 includes an air intake 111, a left front 112, a right front 113, a left side 114, a right side 115, and so on.

The air intake 111 is a conduit for taking in outside air from the under floor side of the vehicle body.

The air intake 111 is disposed on a front side of the left battery pack 10 and the right battery pack 20 in a vehicle width direction central area so as to extend substantially in a vehicle front-rear direction.

An opening for taking in outside air is provided in a front end of the air intake 111. Waterproofing measures such as disposing the open end in a higher position than the other portions and orienting the open end upward, for example, may be implemented to prevent water and the like from infiltrating through the open end.

The left front 112 and the right front 113 are formed to extend respectively in a left-right direction from a rear end of the air intake 111.

The left front 112 and the right front 113 are air flow passages that lead the air introduced thereto from the air intake 111 to respective front ends of the left side 114 and the right side 115.

The left front 112 and the right front 113 are disposed adjacent to respective front ends of the left battery pack 10 and the right battery pack 20.

The left side 114 and the right side 115 are disposed along the respective vehicle width direction outside ends of the left battery pack 10 and the right battery pack 20 so as to extend substantially in the front-rear direction of the vehicle 1.

The left side 114 and the right side 115 project toward a vehicle rear side from respective vehicle width direction outside ends of the left front 112 and the right front 113.

Vehicle width direction inside parts of the left side 114 and the right side 115 communicate with the vehicle width direction outside parts of the left battery pack 10 and the right battery pack 20 via a plurality of connecting holes. The cooling air is supplied to the respective battery packs through these communication sites so as to flow inward in the vehicle width direction substantially horizontally and substantially in the vehicle width direction.

Materials, shapes, and so on of the left side 114 and the right side 115 are set such that a crushing strength thereof relative to a compression load acting in the vehicle width direction is lower than that of the cases of the left battery pack 10 and the right battery pack 20.

Further, respective widths of the left side 114 and the right side 115 in the vehicle width direction are set while taking into consideration a crushable stroke required when the vehicle body is subjected to a side-on collision.

The exhaust duct 120 is constituted by a left side 121, a right side 122, a collector 123, and so on.

The left side 121 and the right side 122 extend in the front-rear direction substantially along the vehicle width direction inside ends of the left battery pack 10 and the right battery pack 20.

As shown in FIG. 1B, the left side 121 and the right side 122 are disposed on either side of a propeller shaft S that transfers driving force from a transmission installed in the front of the vehicle to a rear differential provided in a central area between the left and right rear wheels RW.

Vehicle width direction outside parts of the left side 121 and the right side 122 communicate with the vehicle width direction inside parts of the left battery pack 10 and the right battery pack 20 via a plurality of connecting holes.

The air (exhaust air) that is discharged from the left battery pack 10 and the right battery pack 20 after cooling the cells is introduced into the left side 121 and the right side 122 through these communication sites.

The collector 123 is connected to respective rear ends of the left side 121 and the right side 122 in order to collect the exhaust air discharged from these ends and discharge the exhaust air to the outside through an exhaust port provided near a left-right direction central area of the vehicle body.

According to the first example described above, when a side-on collision occurs in the vehicle, the left side 114 or the right side 115 of the intake duct 110 is crushed such that a space in which the left side 114 or the right side 115 is disposed serves as a crushable space. As a result, a crushable stroke can be secured in the vehicle body while protecting the left battery pack 10 and the right battery pack 20.

Hence, the need to secure a crushable stroke by reducing the width of the battery pack decreases, and therefore an increase in the up-down direction dimension of the battery pack can be avoided. As a result, a reduction in the minimum ground clearance, raising of the center of gravity, a reduction in cabin space, and so on can be prevented.

### Second Example

Next, a second example of the cooling structure for an in-vehicle battery to which the present invention is applied will be described.

Note that in each of the examples described below, identical reference numerals have been allocated to locations that are substantially identical to those of the preceding example, and description thereof has been omitted. The following description focuses mainly on differences between the examples.

FIG. 2 is a pattern diagram showing a configuration of the cooling structure for an in-vehicle battery according to the second example.

In the second example, independent air intakes 116 and 117 are provided on respective fronts of the left side 114 and the right side 115 in place of the air intake 111, the left front 112, and the right front 113 of the intake duct 110 in the cooling apparatus 100 according to the first example.

The air intakes 116 and 117 are conduits that extend substantially in the front-rear direction of the vehicle. Respective front ends of the air intakes 116 and 117 are open, and respective rear ends are connected communicably to the respective front ends of the left side 114 and the right side 115.

The rear ends of the air intakes 116 and 117 are bent into a crank shape such that respective main bodies of the air intakes 116 and 117 are offset inwardly in the vehicle width direction relative to the left side 114 and the right side 115.

With the second example described above, substantially identical effects to the effects of the first example can be obtained.

### Third Example

Next, a third example of the cooling structure for an in-vehicle battery to which the present invention is applied will be described.

FIG. 3 is a pattern diagram showing a configuration of the cooling structure for an in-vehicle battery according to the third example.

In the third example, the cooling air flows from the vehicle width direction inner side toward the vehicle width direction outer side of the left battery pack 10 and the right battery pack 20 via a left side 118 and a right side 119 that are connected communicably to the rear end of the air intake 111, instead of the left front 112, the right front 113, the left side 114, and the right side 115 of the intake duct 110 in the cooling apparatus 100 according to the first example.

The left side 118 and the right side 119 extend substantially in the front-rear direction of the vehicle, and are disposed along the respective vehicle width direction inside ends of the left battery pack 10 and the right battery pack 20.

Further, the exhaust duct 120 is constituted by a left side 124 and a right side 125, which are provided on the respective vehicle width direction outside ends of the left battery pack 10 and the right battery pack 20, and a left discharger 126 and a right discharger 127 provided respectively to the rear of the left side 124 and the right side 125.

The left side 124 and the right side 125 extend substantially in the front-rear direction of the vehicle, and are disposed along the respective vehicle width direction outside ends of the left battery pack 10 and the right battery pack 20.

The left discharger 126 and the right discharger 127 extend substantially in the front-rear direction of the vehicle, and front ends thereof are respectively connected to rear ends of the left side 124 and the right side 125.

The respective front ends of the left discharger 126 and the right discharger 127 are bent into a crank shape such that respective main bodies of the left discharger 126 and the right discharger 127 are offset inwardly in the vehicle width direction relative to the left side 124 and the right side 125.

The exhaust air discharged from the left battery pack 10 and the right battery pack 20 passes through the left side 124, the right side 125, the left discharger 126, and the right discharger 127 and is then discharged to the outside from the respective rear ends of the left discharger 126 and the right discharger 127.

Likewise in the third example described above, the left side 126 or the right side 127 of the exhaust duct 120 is crushed during a side-on collision, and therefore substantially identical effects to the effects of the first example can be obtained.

### Modified Examples

The present invention is not limited to the examples described above, and may be subjected to various changes and modifications which fall within the technical scope of the present invention.
(1) Shapes, structures, arrangements, materials, manufacturing methods, and so on of the respective members constituting the cooling structure for an in-vehicle battery are not limited to those described in the above examples and may be modified appropriately.

For example, the shape and arrangement of the battery packs, laying arrangements of the intake duct and exhaust duct of the cooling apparatus, and so on may be modified appropriately.
(2) In the examples, the battery packs are loaded on the left and right sides so as to sandwich the floor tunnel, but the batteries may be loaded in the central area of the vehicle body instead. In this case, the intake duct may be provided on one side in the vehicle width direction and the exhaust duct may be provided on the other side so that the ducts are crushed during a side-on collision.
(3) The vehicle described in the examples is an engine-electric hybrid vehicle, for example, but the present invention is not limited thereto, and may be applied to various other types of electric vehicles, such as a plug-in hybrid vehicle that can be charged from a power supply facility or an electric automobile that obtains travel power from a motor alone.

What is claimed is:

1. A cooling structure for an in-vehicle battery, comprising:
a battery pack housing a battery cell in a case and loaded into a lower part of a vehicle body;
an intake duct for introducing cooling air into the battery pack; and
an exhaust duct for discharging the cooling air discharged from the battery pack,
wherein a part of at least one of the intake duct and the exhaust duct is disposed along an end of the battery pack in a vehicle width direction and has a lower crushing strength with respect to an input in the vehicle width direction than the battery pack.

2. The cooling structure for an in-vehicle battery according to claim 1, wherein
the battery pack comprises a left battery pack and a right battery pack disposed separately on left and right sides of the vehicle body, and
one of the intake duct and the exhaust duct is disposed at least partially along a vehicle width direction outside end of the left battery pack and the right battery pack and has a lower crushing strength with respect to an input in the vehicle width direction than the battery pack.

3. The cooling structure for an in-vehicle battery according to claim 2, wherein the other of the intake duct and the exhaust duct is disposed at least partially along a vehicle width direction inside end of the left battery pack and the right battery pack.
